(19) United States
(12) Patent Application Publication
(10) Pub. No.: US 2025/0182984 A1
(43) Pub. Date: Jun. 5, 2025

(54) BUTTON ELEMENT AND ELECTRONIC DEVICE

(71) Applicant: Wistron NeWeb Corporation, Hsinchu (TW)

(72) Inventor: Yu-Kai CHIU, Hsinchu (TW)

(21) Appl. No.: 18/799,077

(22) Filed: Aug. 9, 2024

(30) Foreign Application Priority Data
Nov. 30, 2023 (TW) 112146476

(51) Int. Cl. H01H 13/14; H01H 13/04

(52) U.S. Cl. CPC H01H 13/14; H01H 13/04

(57) ABSTRACT

A button element has an elasticity and is configured for being connected to a housing. The button element includes a pressing portion and an open portion. The pressing portion is configured for being exposed from an opening of the housing for a user to press. The open portion extends from a first connecting end to an open end and includes a first cantilever and an open anchoring area in sequence. The first connecting end is connected to the pressing portion, and the open anchoring area is configured to be fixedly connected to the housing.

### RELATED APPLICATIONS

This application claims the benefit of priority to Taiwan Patent Application Serial No. 112146476, filed on Nov. 30, 2023. The entire content of the above identified application is incorporated herein by reference.

### BACKGROUND

### Technical Field

The present disclosure relates to a button element and an electronic device, in particular to a button element including an open end, and an electronic device including the application of the button element.

### Description of Related Art

A common button element is mounted on a housing of an electronic device in the products of the living or industrial environment. A touch switch (tact switch) is on the circuit board adjacent to the button element, so that the user can press the button element and then trigger the touch switch. However, due to the exterior design of the electronic device and the structural arrangements of the internal components, the pressing center of the touch switch may deviate from the center of the button element. In particular, when the user presses the button element under a too large eccentricity, the button element may be pressed deflectedly, or even the touch switch cannot be triggered.

According to the above, the button element and electronic device market nowadays urgently needs to develop a button element and an electronic device that ensure the pressing portion of the button element is stable in the pressing process and suppress excessive skew, and then the button elements and electronic devices are improved to fail to press or feel poor.

### SUMMARY

According to an aspect of the present disclosure, a button element is provided, which has an elasticity and is configured for being connected to a housing. The button element includes a pressing portion and an open portion. The pressing portion is configured for being exposed from an opening of the housing for a user to press. The open portion extends from a first connection end to an open end and includes a first cantilever and an open anchoring area in sequence. The first connection end is connected to the pressing portion, and the open anchoring area is configured to be fixedly connected to the housing.

According to another aspect of the present disclosure, an electronic device including a housing, a button element and a touch switch is provided. The housing includes an opening. The button element includes a pressing portion and an open portion. The pressing portion is exposed from the opening. The open portion extends from a first connection end to an open end and includes a first cantilever and an open anchoring area in sequence. The first connection end is connected to the pressing portion, and the open anchoring area is fixedly connected to the housing. The touch switch is disposed correspondingly to the pressing portion and includes a contact portion. When a user presses the pressing portion, the pressing portion is in contact with the contact portion.

### BRIEF DESCRIPTION OF THE DRAWINGS

The present disclosure can be more fully understood by reading the following detailed description of the embodiment, with reference made to the accompanying drawings as follows:

FIG. 1 is a front view of a button element according to a first embodiment of the present disclosure.

FIG. 2 is a front view of an electronic device according to a second embodiment of the present disclosure.

FIG. 3 is an enlarged view of a portion 3 of FIG. 2.

FIG. 4 is an exploded view of a portion of the electronic device of FIG. 3.

FIG. 5 is a cross-section view of a section line 5-5 of FIG. 2.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an” and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

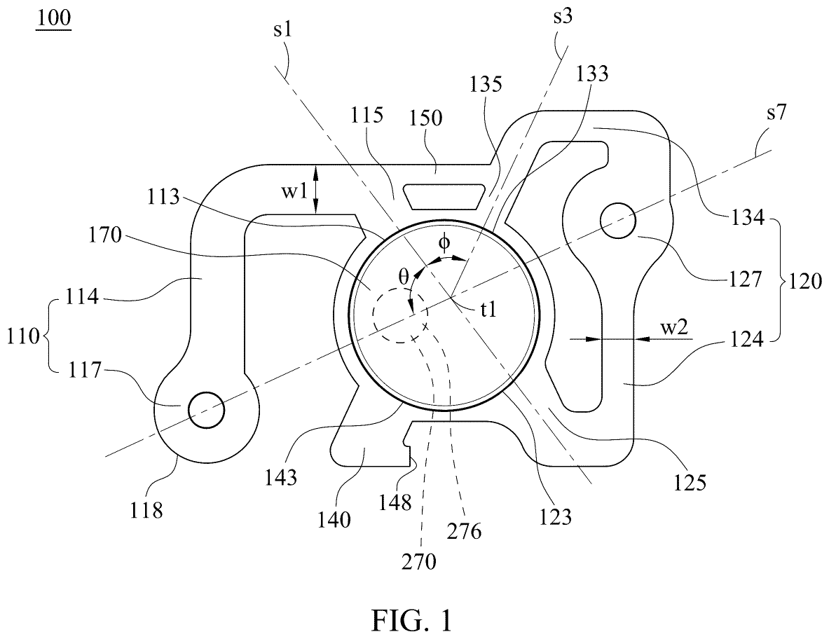

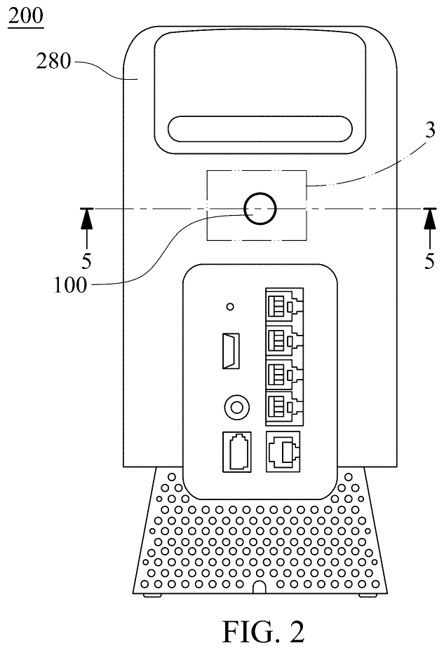

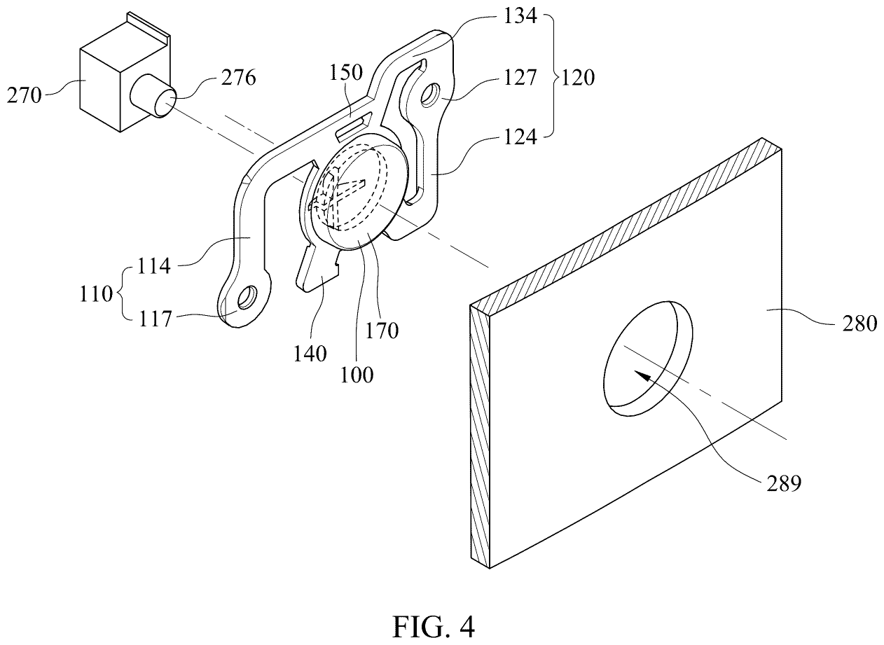

FIG. 1 is a front view of a button element 100 according to a first embodiment of the present disclosure. Referring to FIG. 1, the button element 100 has an elasticity and is configured for being connected to the housing (e.g., the housing 280 shown in FIG. 2 to FIG. 5), and the button element 100 includes a pressing portion 170 and an open portion 110. The pressing portion 170 is configured to be exposed from the opening of the housing (e.g., the opening 289 shown in FIG. 4) for a user to press. The open portion 110 extends from a first connection end 113 to an open end 118 and includes a first cantilever (springing arm) 114 and an open anchoring area 117 in sequence. The first connection end 113 is connected to the pressing portion 170, and the open anchoring area 117 is configured to be fixedly connected to the housing. Further, the open end of the button element 100 in the present disclosure refers to the end that is not connected to the pressing portion 170 but may be configured to be connected with other components (e.g., the housing). Therefore, the button element 100 of the present disclosure can be matched with a variety of electronic device appearance designs and their internal component configurations, including the condition that a touch switch (e.g., a touch switch 270 and its contact portion 276) and the pressing portion 170 are eccentric or not eccentric, and in the process of pressing, ensure that the sinking process of the pressing portion 170 is stable, suppress excessive skew, and then improve the problem of pressing failure or poor pressing feel.

Specifically, the button element 100 may further include a closed portion 120, which extends from a second connection end 123 to a third connection end 133 and includes a second cantilever 124, a closed anchoring area 127, and a third cantilever 134 in sequence. The second connection end 123 and the third connection end 133 are respectively connected to the pressing portion 170, and the closed anchoring area 127 is configured to be fixedly connected to the housing. Therefore, through the design of the “three-pronged” (i.e., the first cantilever 114, the second cantilever 124, and the third cantilever 134 distributed around the periphery of the pressing portion 170), the button element 100 can still ensure the smooth sinking process of the pressing portion 170 even when it is applied to the eccentric condition with the touch switch.

The length of the first cantilever 114 may be greater than the length of the second cantilever 124 and the length of the third cantilever 134. Therefore, the design of “cantilevers with unequal lengths” helps the button element 100 to suppress excessive skew of the pressing portion 170 even when it is applied to the eccentric condition with the touch switch.

A characteristic width of the first cantilever 114 is w1, a characteristic width of the second cantilever 124 is w2, and the characteristic widths w1, w2 refer to the widths of the longest line segments or the main line segments on the first cantilever 114 and the second cantilever 124, respectively, which can satisfy the following condition: w1>w2. Therefore, on the basis of the design of “cantilevers with unequal lengths”, the design of “cantilevers with unequal widths” is further adopted to conform to the design principle of the “moment of inertia of an area” in the field of mechanics, so as to improve the pressing feel. In the first embodiment, the characteristic width w1 is 3.16 mm, and the characteristic width w2 is 2.01 mm. The present disclosure is not limited thereto.

The length of the second cantilever 124 may be greater than the length of the third cantilever 134. Therefore, the first cantilever 114, the second cantilever 124, and the third cantilever 134 are respectively used as the long arm, the short arm, and the shortest auxiliary arm of the button element 100, which are conducive to the application of eccentric design through the special geometric structure of asymmetry.

The first cantilever 114 may extend from the first connection end 113 toward the open anchoring area 117 along an extension direction. The second cantilever 124 may extend from the second connection end 123 toward the closed anchoring area 127 along the same extension direction. The extension direction is either a clockwise direction or a counterclockwise direction around the pressing portion 170. For example, when observed from the perspective of FIG. 1, the extension direction is a counterclockwise direction. Therefore, the button element 100 can be applied to the situation of eccentricity with the touch switch, so that the product design and material selection are more flexible, the probability of being available in stock of the touch switch assembly factory can be improved, the customized development cost is avoided, and the material selection cost of the touch switch is reduced.

The button element 100 may further include a convex portion 140, which extends from a fourth connection end 143 to an open end 148. The first connection end 113, the fourth connection end 143, the second connection end 123, and the third connection end 133 are arranged along the extension direction in sequence. Therefore, the button element 100 can be integrally formed with plastic material. The convex portion 140 can correspond to the injection port in the molding process so as not to affect the design and function of the button element 100. The open anchoring area 117 and the closed anchoring area 127 can be fixedly connected to the housing by hot pressing and hot melting.

The button element 100 may further include a bridge portion 150 connected between the first cantilever 114 and the third cantilever 134. Therefore, it helps to improve the stability of the sinking process of the pressing portion 170.

The width of the bridge portion 150 may be smaller than the width of each of the first cantilever 114, the second cantilever 124, and the third cantilever 134. Therefore, it helps the button element 100 to provide an appropriate and smooth pressing force configuration.

A connection line of the open anchoring area 117 and the closed anchoring area 127 is defined as an anchor connection line s7. A connection line of the first connection end 113 (i.e., the junction center of the first connection end 113 and the pressing portion 170) and the second connection end 123 (i.e., the junction center of the second connection end 123 and the pressing portion 170) is defined as a first connection line s1. A first angle θ is formed between a segment of the anchor connection line s7 related to (i.e., adjacent to) the open anchoring area 117 and a segment of the first connection line s1 related to the first connection end 113. It can satisfy the following condition: 30 degrees≤θ≤90 degrees. Therefore, the first cantilever 114 and the second cantilever 124 have appropriate relative positions to allow the eccentric design of the pressing portion 170, which is conducive to improve the flexibility of the stacked design in the electronic device, thereby improving the efficiency of product development.

The anchor connection line s7 and the first connection line s1 have an intersection point t1 (which can be located or not located in the center of the pressing portion 170). A connection line of the third connection end 133 (i.e., the junction center of the third connection end 133 and the pressing portion 170) and the intersection point t1 is defined as a third connection line s3. A third angle ϕ is formed between the segment of the first connection line s1 related to the first connection end 113 and a segment of the third connection line s3 related to the third connection end 133, which can satisfy the following condition: θ+ϕ≤180 degrees. Furthermore, it can satisfy the following conditions at the same time: 30 degrees≤θ≤90 degrees, and 30 degrees<θ+ϕ≤180 degrees. Therefore, the appropriate configuration position of the third cantilever 134 is conducive to applying the button element 100 of special geometry to eccentric pressing. In the first embodiment, the first angle θ is 78 degrees, the third angle ϕ is 62 degrees, θ+ϕ is 140 degrees, and the present disclosure is not limited thereto.

A line segment 115 of the first cantilever 114 connecting the first connection end 113 can extend in parallel to the first connection line s1. A line segment 125 of the second cantilever 124 connecting the second connection end 123 can extend in parallel to the first connection line s1. A line segment 135 of the third cantilever 134 connecting the third connection end 133 can extend in parallel to the third connection line s3. Therefore, the pressing portion 170 can be better prevented from being excessively skewed during eccentric pressing.

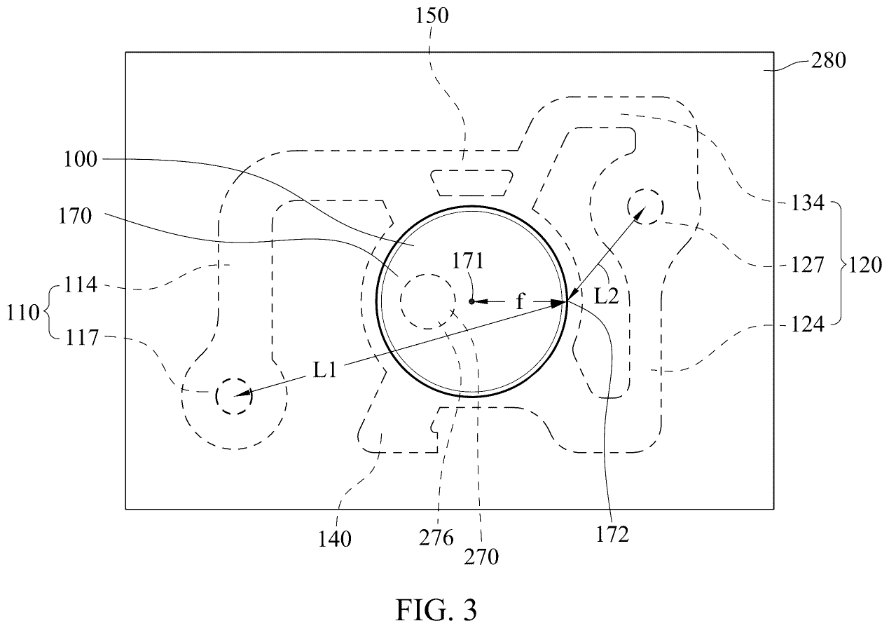

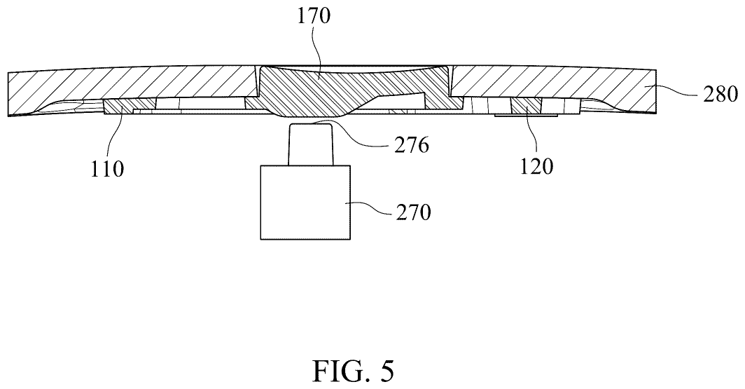

FIG. 2 is a front view of an electronic device 200 according to a second embodiment of the present disclosure. FIG. 3 is an enlarged view of a portion 3 of FIG. 2. FIG. 4 is an exploded view of a portion of the electronic device 200 of FIG. 3. FIG. 5 is a cross-section view of a section line 5-5 of FIG. 2. FIG. 3 to FIG. 5 omit other components that are less relevant to the present disclosure. Referring to FIG. 2 to FIG. 5, the electronic device 200 includes the housing 280, the button element 100 of the first embodiment, and the touch switch 270. The electronic device 200 is specifically a computer host, and the present disclosure is not limited thereto. The housing 280 includes the opening 289. The button element 100 includes the pressing portion 170 and the open portion 110. The pressing portion 170 is exposed from the opening 289. The open portion 110 extends from the first connection end 113 to the open end 118 and includes a first cantilever 114 and an open anchoring area 117 in sequence. The first connection end 113 is connected to the pressing portion 170, and the open anchoring area 117 is fixedly connected to the housing 280. The touch switch 270 is disposed correspondingly to the pressing portion 170 and includes a contact portion 276. When the user presses the pressing portion 170, the pressing portion 170 is in contact with the contact portion 276. Specifically, a rib on the surface of the pressing portion 170 facing the inner side of the electronic device 200 may contact the contact portion 276. Therefore, the electronic device 200 of the present disclosure can achieve the effect that the touch switch 270 can be successfully triggered by pressing at any position of the pressing portion 170, thereby improving the texture of the product.

Specifically, referring to FIG. 3 and FIG. 5, the closed anchor area 127 is fixedly connected to the housing 280. The contact portion 276 can be disposed eccentrically and correspondingly to the pressing portion 170. Therefore, the button element 100 can be used in eccentric or non-eccentric situation, helping to increase the design flexibility of the electronic device 200 and reduce development costs. In the second embodiment, when the button element 100 is applied to an eccentric situation, the corresponding position of the contact portion 276 of the touch switch 270 deviates from the button center 171 toward the open portion 110. In other embodiments (not shown in the figures) according to the present disclosure, the corresponding position of the contact portion 276 may deviate from the button center 171 toward the closed portion 120.

Referring to FIG. 3, the pressing portion 170 has a most oblique pressing position 172 farthest away from the contact portion 276. The distance between the center of the open anchoring area 117 and the most oblique pressing position 172 is L1, and the distance between the center of the closed anchor area 127 and the most oblique pressing position 172 is L2, which can satisfy the following condition: L2<L1. Therefore, through the specific configuration of the open anchoring area 117 and the closed anchoring area 127, even pressing the pressing portion 170 at the most oblique pressing position 172 helps to ensure that it is in contact with the touch switch 270. In the second embodiment, the distance L1 is 21.87 mm, and the distance L2 is 7.79 mm. The present disclosure is not limited thereto.

The center of the pressing portion 170 is the button center 171. A distance between the most oblique pressing position 172 and the button center 171 is f. A reference distance is L3, which is defined as:

$$L 3 = \frac{3 \times {( L 1 - f )}^{2} - L {1}^{2}}{2 \times L 1} ,$$

which can satisfy the following condition: 0.7×L3≤L2≤1.3×L3. Therefore, pressing failures can be avoided and the pressing feel can be improved. In the second embodiment, the distance f is 6 mm, the reference distance L3 is 6.34 mm, and the present disclosure is not limited thereto. It is noted that all of the distances L1, L2, and f have distance components in x and y directions (the distance components can be equal to or greater than 0). For example, the transverse direction is defined as x-direction, and the longitudinal direction is defined as y-direction in FIG. 3. The distances L1, L2, and f can be calculated from the distance components in x and y directions.

For other details about the button element 100 in the electronic device 200, please refer to the button element 100 in the first embodiment as illustrated above, and will not be repeated herein.

The foregoing description of the disclosure has been presented only for the purposes of illustration and description option of the exemplary embodiments and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A button element, having an elasticity and configured for being connected to a housing, the button element comprising:
a pressing portion configured for being exposed from an opening of the housing for a user to press; and
an open portion extending from a first connection end to an open end and comprising a first cantilever and an open anchoring area in sequence, wherein the first connection end is connected to the pressing portion, and the open anchoring area is configured to be fixedly connected to the housing.

2. The button element according to claim 1, further comprising:
a closed portion extending from a second connection end to a third connection end and comprising a second cantilever, a closed anchoring area, and a third cantilever in sequence, wherein the second connection end and the third connection end are respectively connected to the pressing portion, and the closed anchoring area is configured to be fixedly connected to the housing.

3. The button element according to claim 2, wherein a length of the first cantilever is greater than a length of the second cantilever and a length of the third cantilever.

4. The button element according to claim 2, wherein a length of the second cantilever is greater than a length of the third cantilever.

5. The button element according to claim 2, wherein the first cantilever extends from the first connection end toward the open anchoring area along an extension direction, the second cantilever extends from the second connection end toward the closed anchoring area along the extension direction, and the extension direction is either a clockwise direction or a counterclockwise direction around the pressing portion.

6. The button element according to claim 5, further comprising:
a convex portion extending from a fourth connection end to another open end, wherein the first connection end, the fourth connection end, the second connection end, and the third connection end are arranged in sequence along the extension direction.

7. The button element according to claim 2, further comprising:
a bridge portion connected between the first cantilever and the third cantilever.

8. The button element according to claim 7, wherein a width of the bridge portion is smaller than a width of each of the first cantilever, the second cantilever and the third cantilever.

9. The button element according to claim 2, wherein a connection line of the open anchoring area and the closed anchoring area is defined as an anchor connection line, a connection line of the first connection end and the second connection end is defined as a first connection line, a first angle is formed between a segment of the anchor connection line related to the open anchoring area and a segment of the first connection line related to the first connection end, and the first angle is θ satisfying the following condition:
$$30 degrees \leq θ \leq 90 degrees .$$

10. The button element according to claim 9, wherein the anchor connection line and the first connection line have an intersection point, a connection line of the third connection end and the intersection point is defined as a third connection line, a third angle is formed between the segment of the first connection line related to the first connection end and a segment of the third connection line related to the third connection end, and the third angle is satisfying the following condition:
$$θ + ϕ \leq 180 degrees .$$

11. The button element according to claim 10, wherein a line segment of the third cantilever connecting the third connection end extends in parallel to the third connection line.

12. The button element according to claim 9, wherein a line segment of the first cantilever connecting the first connection end extends in parallel to the first connection line, and a line segment of the second cantilever connecting the second connection end extends in parallel to the first connection line.

13. The button element according to claim 2, wherein a characteristic width of the first cantilever is w1, a characteristic width of the second cantilever is w2, and the following condition is satisfied:
w1>w2.

14. An electronic device, comprising:
a housing comprising an opening;
a button element comprising a pressing portion and an open portion, wherein the pressing portion is exposed from the opening, the open portion extends from a first connection end to an open end and comprises a first cantilever and an open anchoring area in sequence, the first connection end is connected to the pressing portion, and the open anchoring area is fixedly connected to the housing; and
a touch switch disposed correspondingly to the pressing portion and comprising a contact portion;
wherein when a user presses the pressing portion, the pressing portion is in contact with the contact portion.

15. The electronic device according to claim 14, wherein the contact portion is disposed eccentrically and correspondingly to the pressing portion.

16. The electronic device according to claim 14, wherein the button element further comprises a closed portion extending from a second connection end to a third connection end and comprising a second cantilever, a closed anchoring area, and a third cantilever in sequence, the second connection end and the third connection end are respectively connected to the pressing portion, and the closed anchoring area is fixedly connected to the housing.

17. The electronic device according to claim 16, wherein the pressing portion has a most oblique pressing position farthest away from the contact portion, a distance between a center of the open anchoring area and the most oblique pressing position is L1, a distance between a center of the closed anchoring area and the most oblique pressing position is L2, and the following condition is satisfied:
L2<L1.

18. The electronic device according to claim 17, wherein the pressing portion has a button center, a distance between the most oblique pressing position and the button center is f, and a reference distance is L3 defined as:
$$L 3 = \frac{3 \times {( L 1 - f )}^{2} - L {1}^{2}}{2 \times L 1} ;$$
and the following condition is satisfied:
$$0.7 \times L 3 \leq L 2 \leq 1.3 \times L 3 .$$
